(19) United States
(12) Patent Application Publication
(10) Pub. No.: US 2022/0058062 A1
(43) Pub. Date: Feb. 24, 2022

(54) SYSTEM RESOURCE ALLOCATION FOR CODE EXECUTION

(71) Applicant: Intel Corporation, Santa Clara, CA (US)

(72) Inventors: Rafal SZTEJNA, Gdansk (PL); Piotr WYSOCKI, Gdansk (PL); Pawel ZAK, Gdansk (PL); Przemyslaw PERYCZ, Sopot (PL); Szymon KONEFAL, Gdansk (PL)

(21) Appl. No.: 17/520,700

(22) Filed: Nov. 7, 2021

(51) Int. Cl. G06F 9/50; G06F 9/54

(52) U.S. Cl. CPC G06F 9/5055; G06F 9/545; G06F 9/5044

(57) ABSTRACT

Examples described herein relate to an including at least one processor and a system agent communicatively coupled to the at least one processor. In some examples, the at least one of the at least one processor, when operational, is configured to: execute an operating system (OS) to: receive a call to perform a kernel-level operation and adjust settings of system resources assigned to perform the kernel-level operation based on a class of service associated with the call.

### BACKGROUND

Cloud computing provides a client device with access to computing and storage resources of remote computers. The client can make use of a remote computer or cluster of computers to perform a variety of processing or computing operations as well as remote data processing and data storage or retrieval. For example, a client can be a smart phone, Internet-of-Things (IoT) compatible device such as a smart home, building appliance (e.g., refrigerator, light, camera, or lock), wearable device (e.g., health monitor, smart watch, smart glasses), connected vehicle (e.g., self-driving car), and smart city (e.g., traffic sensor, parking sensor, energy use sensor). Remote computers or clusters of computers can include a data center that is connected to the client using a high-speed networking connection. However, transferring data from the client to a remote computer can incur an unacceptable latency for time-sensitive applications that have strict requirements for promptly receiving results from the remote computer.

Input output (IO) devices, such as network interface devices and storage devices, are available to computing systems such as servers to transmit and receive packets. Applications executed by a server utilize an operating system (OS) and driver to interface with the network interface devices. Execution of kernel operations in the OS can delay access to the IO devices and lead to low workload queue depth of inputs to the IO devices. This can cause Service Level Agreement (SLA) violations by the system. Poll-mode driver-based applications allow omission of routines in kernel space to access IO devices, but may involve application redesign and force use of particular hardware-specific drivers.

### BRIEF DESCRIPTION OF THE DRAWINGS

FIG. 1 depicts an example system.

FIG. 2 depicts an example operation.

FIG. 3 depicts an example process.

FIG. 4 depicts an example system.

### DETAILED DESCRIPTION

Execution of kernel code in response to a request from a user space process or while handling interrupts can have various system resource needs. In some examples, received requests to perform kernel code can be classified and configuration of system resources can be adjusted for the duration of handling such requests to attempt to improve workload performance. A kernel can be configured to apply a class of service to requests received from user-space and modify resources available to perform the kernel-level request can be modified based on the assigned class of service. When request handling is completed, system resources settings can be restored to a prior setting or other level.

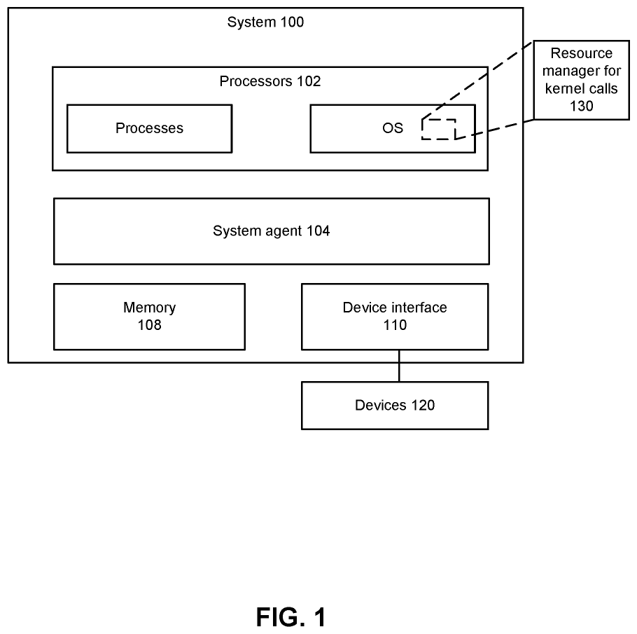

FIG. 1 depicts an example system. The system can be implemented as part of a server, rack of servers, computing platform, or others. In some examples, processors 102 can include one or more of: a central processing unit (CPU) core, graphics processing unit (GPU), field programmable gate array (FPGA), accelerator or application specific integrated circuit (ASIC). Processors 102 can include an XPU, where an XPU can include at least to: a CPU, a graphics processing unit (GPU), general purpose GPU (GPGPU), or other processing units (e.g., accelerator). In some examples, a core can be sold or designed by Intel®, ARM®, AMD®, Qualcomm®, IBM®, Texas Instruments®, among others.

Processors 102 can execute an operating system (OS), driver, and/or processes. In some examples, an OS can include Linux®, Windows® Server, FreeBSD®, Android®, MacOS®, iOS®, or any other operating system. A driver can provide configuration and use of any device such as devices 120. A processor executed process can include one or more of: applications, virtual machines (VMs), containers, microservices, serverless applications, and so forth.

Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

An uncore or system agent 104 can include or more of a memory controller, a shared cache (e.g., last level cache (LLC)), a cache coherency manager, arithmetic logic units, floating point units, core or processor interconnects, Caching/Home Agent (CHA), or bus or link controllers. System agent 104 can provide one or more of: direct memory access (DMA) engine connection, non-cached coherent master connection, data cache coherency between cores and arbitrates cache requests, or Advanced Microcontroller Bus Architecture (AMBA) capabilities.

Some implementations of OS provide different levels of access to device resources corresponding to different privilege rings. Ring 0 provides a highest level of privilege and permits access to device resources (e.g., CPU and memory). Kernel and kernel code can be affiliated with Ring 0. Ring 3 can provide a lower level of access than that of Ring 0 to device resources. Applications can be affiliated with Ring 3. Rings 1 and 2 can provide more access to device resources than that of Ring 3 but less access to device resources that that of Ring 0. Device drivers can be affiliated with Rings 1 and 2.

A user-space executed process can issue calls to an OS that cause execution of code in kernel space. For example, a call can include a system call, such as instructions SYSCALL/SYSRET and SYSENTER/SYSEXIT. A system call can transfer control to the kernel for a system call without an interrupt. Some examples assign a class of service to various calls from user-space executed processes (e.g., IO read/write, page fault exceptions, and so forth) that cause execution of kernel space code. When or prior to execution of kernel space code, resource manager 130 can configure system resources used to execute kernel space code based at least on the class of service. For example, resource manager 130 utilized by an operating system can adjust platform resources available to execute the kernel space code, such as one or more of: increasing frequency of a CPU core, increasing frequency of an uncore or system agent, or increasing frequency of operation of other devices such as an accelerator, memory controller, storage controller, or network interface controller. In some examples, resource manager 130 can adjust a sleep state of a CPU core or device during execution of kernel space code to exit sleep state.

For example, resource manager 130 can set faster core and uncore frequencies triggered for a request from a user-space process for packet processing in kernel space at Ring 0 to provide for faster packet availability to the user-space process. Faster processing of packet processing operations in Ring 0 can decrease context switching or scheduling at the operating system in response to a user space application issued a system call, which can slow application performance. System call performance can be improved to improve application performance. In some cases, specialized or custom user space software that bypass Ring 0 need not be created or utilized.

Memory 108 can include one or more of: one or more registers, one or more cache devices (e.g., level 1 cache (L1), level 2 cache (L2), level 3 cache (L3), last level cache (LLC)), volatile memory device, non-volatile memory device, or persistent memory device. For example, memory 108 can include static random access memory (SRAM) memory technology or memory technology consistent with high bandwidth memory (HBM), or double data rate (DDR), among others.

Memory 108 can be connected to processors 102 and/or devices 120 using device interface 110. Device interface 110 can be consistent with Double Data Rate (DDR), Compute Express Link (CXL) (e.g., Compute Express Link Specification revision 2.0, version 0.9 (2020), as well as earlier versions, revisions or variations thereof), Peripheral Component Interconnect express (PCIe) (e.g., PCI Express Base Specification 1.0 (2002), as well as earlier versions, revisions or variations thereof), or other interfaces. In some examples, system 100 can be formed as a system on chip (SoC).

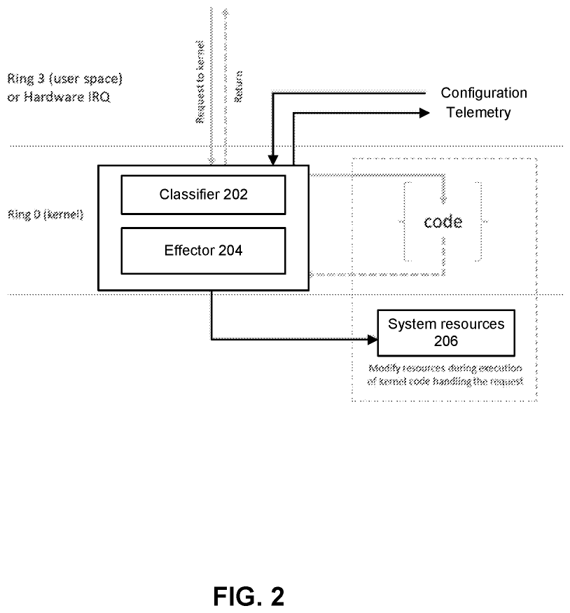

FIG. 2 depicts an example operation of a system. An orchestrator (not depicted) can provide a configuration to classifier 202 to identify and actions for effector 204 to perform based on signals identified by classifier. Orchestrator can identify signal-to-class mappings for the signals. Examples of orchestrators include: Kubernetes, Management and Orchestration (MANO), Docker, and so forth. In some examples, classifier 202 and effector 204 can be part of an operating system. For example, a signal can be associated with a class based on one or more of: system call identifier (SYSCALL ID), Resource Manager Identifier (RMID), specific Peripheral Component Interconnect Express (PCIe) device type, Process Address Space ID (PASID), interrupt request (IRQ) (e.g., PCIe Message Signaled Interrupts (MSI-X)), and so forth. Classifier 202 can be configured with signal-to-class mappings. Effector 204 can be configured with pre-defined actions to modify operation of system resources 206 for particular classes of service. Example actions include increasing or decreasing supplied power or frequencies to CPU core, increasing or decreasing supplied power or frequencies to uncore, increasing or decreasing cache and memory bandwidth (e.g., rate at which data is read from or written to cache or memory), device reconfiguration over PCIe, and so forth.

System resources 206 can include one or more of: CPU core power, CPU core frequency of operation, uncore or system agent power, uncore or system agent frequency of operation, power supplied to a device or frequency of operation of a device. A device can include one or more of: an accelerator, network interface device, storage controller, memory controller, and so forth. A network interface device can include one or more of: a network interface controller (NIC), a remote direct memory access (RDMA)-enabled NIC, SmartNIC, router, switch, forwarding element, infrastructure processing unit (IPU), data processing unit (DPU), or network-attached appliance (e.g., storage, memory, accelerator, processors, security). In some examples, CPU uncore frequency can be correlated with performance of input/output operations such as data transfers to or from devices such as a network interface device, solid state drive (SSD), and so forth.

Some operations in kernel space can be assigned a higher class than other operations and prioritized over operations. Effector 204 can configure system resources 206 based on priority of a kernel call. For example, for higher priority kernel space calls, effector 204 can increase one or more of: CPU core frequency, uncore frequency, and/or cache and memory bandwidth. For lower priority kernel space calls, if an applicable service level agreement (SLA) class is not violated, effector 204 can decrease one or more of: CPU core frequency, uncore frequency, and/or cache and memory bandwidth.

Telemetry can identify to a user space application or orchestrator one or more of: a count of rules that have been executed by effector or time spent for code execution of a rule. User space application or orchestrator can adjust rules and actions of classifier 202 and effector 204 based on telemetry data such as to configure higher power and/or frequency of operation for a processor, uncore, and/or device if performance is inadequate and does not meet an SLA. For example, based on telemetry data, adjustments can be made to cache allocation amount, memory bandwidth allocation, priorities of input/output queues, CPU core settings related to prefetcher policy, Out Of Order execution policy, branch prediction policy, and so forth.

The following describes various examples. In some examples, a user space process issues synchronous SYSCALLs to kernel space. Classifier 202 assigns a class of service based on SYSCALL ID coming from user space. Effector 204 can modify values for performing this call, such as one or more of: CPU core and uncore power and/or frequencies, allocated memory bandwidth, applying CPU core settings related to cache prefetcher policy, out of order execution policy, branch prediction policy, and/or device interface specific setting (e.g., PCIe or CXL) to configure a priority of a specific device IO queue. Upon returning to user space the frequencies are restored to previous or other values.

In some examples, a user space process issues asynchronous IO calls submission and PCIe IRQ are issued by a hardware to indicate completion. During request submission, classifier 202 assigns a class of service based on IO call being made. Effector 204 changes CPU core and uncore frequencies and IO device settings to configured values for performing this call. At or after queuing a request to the IO device, the frequencies of the CPU core and uncore can be restored to previous or other levels. During request completion, classifier 202 assigns a class of service based on PCI IRQ (MSI-X number) and effector 204 changes CPU core and uncore frequencies and/or memory bandwidth to configured values for handling this completion. At or after the completion, the CPU core and uncore power and/or frequencies and/or memory bandwidth are restored to previous or other values.

In some examples, a user space process issues asynchronous IO calls with tracing capability. During request submission, classifier 202 can assign a class of service associated with the received IO call with tracing capability. Based on the class associated with the received call, effector 204 can change CPU core and uncore power and/or frequencies, memory bandwidth, and/or IO device settings to configured values for handling this call. Upon queuing the request to the IO device, the frequencies can be restored to previous or other values. A class of service tag can be used by the IO device. During or after request completion, classifier 202 can assign a class of service based on the tag that was passed to IO device and effector 204 can change CPU core and uncore frequencies to configured values associated with the completion. At or after the completion, the change CPU core and uncore power and/or frequencies, memory bandwidth, and/or IO device settings are set to previous or other values.

Table 1 depicts an example of classifier conditions and effector actions.

| | | |
|---|---|---|
| Example call from user- | Example effect | Potential benefit, but |
| space | | not a necessary |
| | | outcome |
| Storage read operation | CPU Uncore frequency = | Increasing speed of |
| issued by a database | MAX_UNCORE_FREQ | handling read |
| application. | | operations can reduce |
| system call ID = read | CPU Core frequency = | perceived database |
| from file descriptor | MAX_CORE_FREQ | latency and increase |
| PASID = database | | quality of service |
| Process ID (PID) | | |
| retrieved from operating | | |
| system (e.g., a runtime | | |
| variable). | | |
| Storage write operation | CPU Core frequency = | Preserve thermal and |
| issued by a database | DEFAULT_CORE_FREQ | power budget of a CPU |
| application | | for higher priority |
| system call ID = write to | // Uncore frequency is not specified in this | operations which have |
| file descriptor | rule and can remain unchanged | direct impact on Key |
| PASID = database PID | | Performance |
| | | Indicators (KPIs) |
| Network interface | CPU Core frequency = | Higher priority virtual |
| controller (NIC) card | MAX_CORE_FREQ | machine receives |
| MSI-X interrupt handling | Virtual Machine Allocated Memory | resources to satisfy |
| routine | Bandwidth = | SLA. |
| PCIe device | VERY_HIGH_MEMORY_BANDWIDTH | |
| Bus:Device.Function | | |
| (BDF) = identifier of | | |
| Virtual Function of a | | |
| device assigned to a | | |
| Virtual Machine running | | |
| a critical application | | |
| MSI-X ID = interrupt | | |
| vector related to queue | | |
| used for obtain workload | | |
| requested by customer | | |
| NIC card MSI-X interrupt | CPU Core frequency = | Backup functionality |
| handling routine | DEFAULT_CORE_FREQ | of high priority |
| PCIe device BDF = | Virtual Machine Allocated Memory | application virtual |
| identifier of Virtual | Bandwidth = | machine receives |
| Function of a device | | increased amount of |
| assigned to a Virtual | HIGH_MEMORY_BANDWIDTH | resources. |
| Machine running critical | | |
| application | | |
| MSI-X ID = interrupt | | |
| vector related to queue | | |
| used for handling | | |
| application backup | | |
| functionality | | |
| NIC card MSI-X interrupt | CPU Core frequency = | Lower priority virtual |
| handling routine | DEFAULT_CORE_FREQ | machine can receive |
| PCIe device BDF is not | Virtual Machine Allocated Memory | standard amount of |
| identifier of Virtual | Bandwidth = | resources. |
| Function of a device | DEFAULT_MEMORY_BANDWIDTH | |
| assigned to a Virtual | | |
| Machine running critical | | |
| application | | |
| MSI-IX ID can be any | | |
| value | | |

Kernel space operations can reflect a called System Call such as read from file descriptor, write to file descriptor, and so forth. Some amount of kernel space processing is in answer to an interrupt from a device connected through a device interface (e.g., PCIe or CXL).

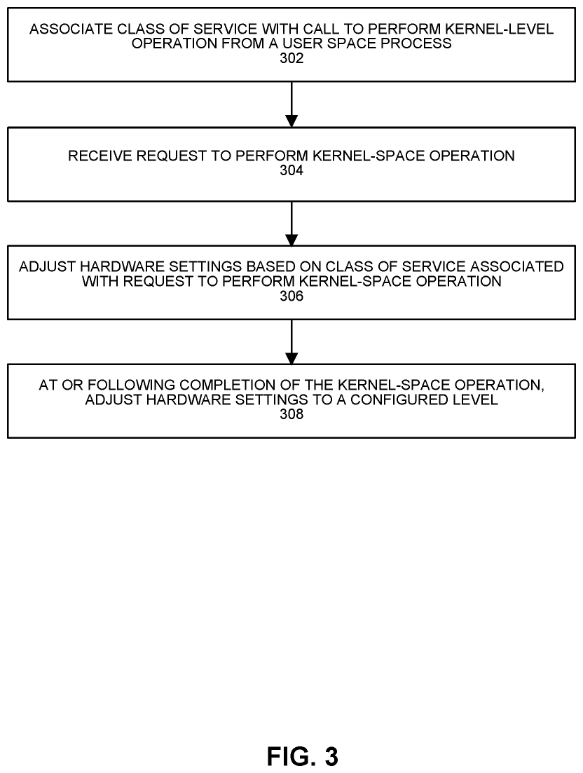

FIG. 3 depicts an example process. The process can be performed by an operating system, uncore, system agent, or other processor. At 302, an operating system can be configured to associate at least one class of service with a request to perform an operation in kernel space. For example, a requester of a kernel space operation, received call type, received call identifier, or operation to be performed in kernel space can be associated with a class of service. An orchestrator can configure the operating system to associate the at least one class of service with a request to perform an operation in kernel space.

At 304, a call can be received to perform an operation in a kernel-space. For example, the request can be provided by a user-space process. The request can identify a kernel space operation to be performed.

At 306, based on configured settings, hardware resource settings can be adjusted to perform the kernel-space operation. For example, hardware resources settings can include one or more of: power supplied to a processor that performs the process that requested a kernel-space operation, frequency of operation of a processor that performs the process that requested a kernel-space operation, power supplied to an uncore associated with the processor that performs the process that requested a kernel-space operation, frequency of operation of an uncore associated with the processor that performs the process that requested a kernel-space operation, power supplied to a particular device, frequency of operation of the particular device, and/or allocated memory access bandwidth. Execution of kernel space code can occur in a same CPU core which called system call from user-space. In some examples, change to frequency of operation can be applied to a core that executes a user-space process that requested kernel-level operation.

At 308, based on completion of the kernel-space operation, hardware resource settings can be adjusted. For example, hardware resource settings can be adjusted to a level prior to the adjusted level made in 306. For example, hardware resource settings can be adjusted to a default configured level that is to be utilized after performance of a requested kernel space operation.

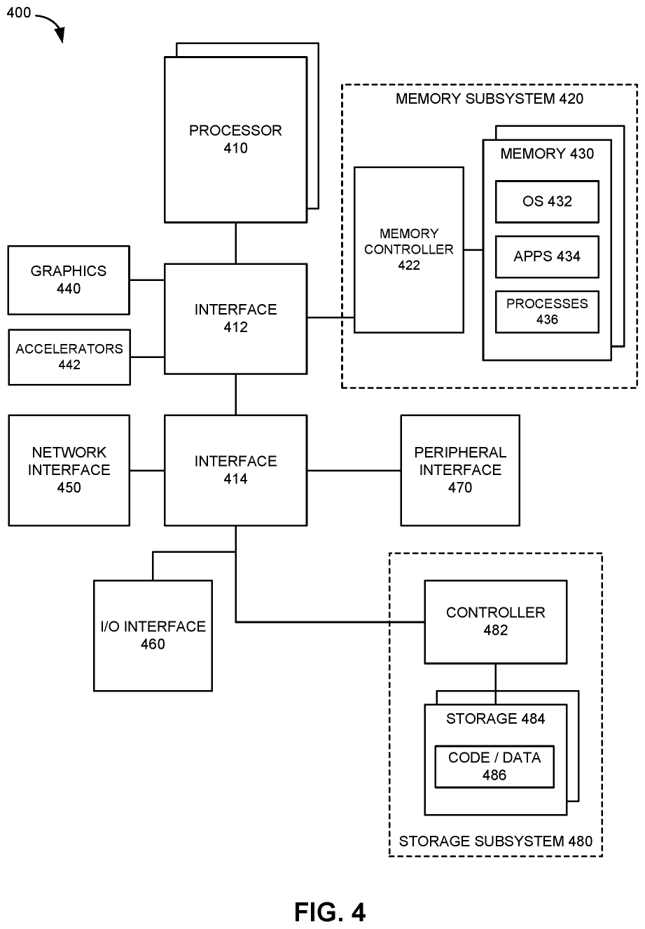

FIG. 4 depicts an example computing system. System 400 can be used to associated kernel-space calls with classes of service and adjust resource settings, as described herein. Processor 410 can include any type of microprocessor, central processing unit (CPU), graphics processing unit (GPU), processing core, or other processing hardware to provide processing for system 400, or a combination of processors. Processor 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 400 includes interface 412 coupled to processor 410, which can represent a higher speed interface or a high throughput interface for system components that needs higher bandwidth connections, such as memory subsystem 420 or graphics interface components 440, or accelerators 442. Interface 412 represents an interface circuit, which can be a standalone component or integrated onto a processor die. Where present, graphics interface 440 interfaces to graphics components for providing a visual display to a user of system 400. In one example, graphics interface 440 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 440 generates a display based on data stored in memory 430 or based on operations executed by processor 410 or both. In one example, graphics interface 440 generates a display based on data stored in memory 430 or based on operations executed by processor 410 or both.

Accelerators 442 can be a fixed function or programmable offload engine that can be accessed or used by a processor 410. For example, an accelerator among accelerators 442 can provide compression (DC) capability, cryptography services such as public key encryption (PKE), cipher, hash/authentication capabilities, decryption, or other capabilities or services. In some embodiments, in addition or alternatively, an accelerator among accelerators 442 provides field select controller capabilities as described herein. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 442 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 420 represents the main memory of system 400 and provides storage for code to be executed by processor 410, or data values to be used in executing a routine. Memory subsystem 420 can include one or more memory devices 430 such as read-only memory (ROM), flash memory, one or more varieties of random access memory (RAM) such as DRAM, or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Processes 436 represent agents or routines that provide auxiliary functions to OS 432 or one or more applications 434 or a combination. OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processor 410 or a physical part of interface 412. For example, memory controller 422 can be an integrated memory controller, integrated onto a circuit with processor 410.

In some examples, OS 432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers or other computing devices) over one or more networks. Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory.

Some examples of network interface 450 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 400 includes one or more input/output (I/O) interface(s) 460. I/O interface 460 can include one or more interface components through which a user interacts with system 400 (e.g., audio, alphanumeric, tactile/touch, or other interfacing). Peripheral interface 470 can include any hardware interface not specifically mentioned above. Peripherals refer generally to devices that connect dependently to system 400. A dependent connection is one where system 400 provides the software platform or hardware platform or both on which operation executes, and with which a user interacts.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processor 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processor 410 or can include circuits or logic in both processor 410 and interface 414.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 400. More specifically, power source typically interfaces to one or multiple power supplies in system 400 to provide power to the components of system 400. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes a computer-readable medium comprising instructions stored thereon, that if executed by one or more processors, cause the one or more processors to: receive a call to perform a kernel-level operation and adjust settings of system resources during performance of kernel-level operation.

Example 2 includes one or more examples, wherein the adjust settings of system resources during performance of kernel-level operation is based on a class of service associated with the call and the class of service is based on a source of the call.

Example 3 includes one or more examples, wherein the class of service is based on a system call identifier of kernel code to be executed.

Example 4 includes one or more examples, wherein the settings of the system resources comprise one or more of: power supplied to a core that executes a user-space application that provided the call, frequency supplied to the core that executes a user-space application that provided the call, power supplied to an uncore associated with the core, frequency supplied to the uncore associated with the core, allocated memory bandwidth, power or frequency of an accelerator device, cache prefetcher policy, out of order execution policy, branch prediction policy, and/or device interface specific setting.

Example 5 includes one or more examples, and includes instructions stored thereon, that if executed by one or more processors, cause the one or more processors to: adjust settings of the system resources to a second level after performance of the called kernel-level operation.

Example 6 includes one or more examples, wherein the second level comprises power and/or frequency settings to core or uncore prior to receipt of the called kernel-level operation.

Example 7 includes one or more examples, and includes instructions stored thereon, that if executed by one or more processors, cause the one or more processors to: selectively adjust settings of the system resources assigned to perform the kernel-level operation based on telemetry associated with prior executions of the kernel-level operation.

Example 8 includes one or more examples, and includes an apparatus comprising: at least one processor; a system agent communicatively coupled to the at least one processor, wherein: at least one of the at least one processor, when operational, is configured to: execute an operating system (OS) to: receive a call to perform a kernel-level operation and adjust settings of system resources assigned to perform the kernel-level operation based on a class of service associated with the call.

Example 9 includes one or more examples, wherein the class of service is based on a source of the call.

Example 10 includes one or more examples, wherein the class of service is based on a system call identifier of kernel code to be executed.

Example 11 includes one or more examples, wherein the settings of the system resources comprise one or more of: power supplied to a core that executes a user-space application that provided the call, frequency supplied to the core that executes a user-space application that provided the call, power supplied to an uncore associated with the core, frequency supplied to the uncore associated with the core, allocated memory bandwidth, power or frequency of an accelerator device, cache prefetcher policy, out of order execution policy, branch prediction policy, and/or device interface specific setting.

Example 12 includes one or more examples, wherein the at least one of the at least one processor, when operational, is configured to: adjust settings of the system resources to a second level after performance of the call to perform the kernel-level operation.

Example 13 includes one or more examples, wherein the second level comprises power and/or frequency settings to core or uncore prior to receipt of the call to perform the kernel-level operation.

Example 14 includes one or more examples, wherein the at least one of the at least one processor, when operational, is configured to: selectively adjust settings of the system resources assigned to perform the kernel-level operation based on telemetry associated with prior executions of the kernel-level operation.

Example 15 includes one or more examples, and includes a server that comprises the at least one of the at least one processor and the system resources subject to adjusted settings.

Example 16 includes one or more examples, and includes a datacenter that comprises the server, wherein the datacenter comprises a second server that executes an orchestrator and wherein the orchestrator is to configure settings of system resources assigned to perform the kernel-level operation based on a class of service.

Example 17 includes one or more examples, and includes a method comprising: adjusting settings of system resources based on class of service associated with a kernel-space operation.

Example 18 includes one or more examples, wherein the class of service is based on a source of a call to perform the kernel-space operation and/or a system call identifier of the kernel-space operation.

Example 19 includes one or more examples, wherein the settings of the system resources comprise one or more of: power supplied to a core that executes a user-space application that provided a call for the kernel-space operation, frequency supplied to the core that executes a user-space application that provided the call, power supplied to an uncore associated with the core, frequency supplied to the uncore associated with the core, allocated memory bandwidth, power or frequency of an accelerator device, cache prefetcher policy, out of order execution policy, branch prediction policy, and/or device interface specific setting.

Example 20 includes one or more examples, and includes selectively adjusting settings of the system resources assigned to perform the kernel-space operation based on telemetry associated with prior executions of the kernel-space operation.

What is claimed is:

1. A computer-readable medium comprising instructions stored thereon, that if executed by one or more processors, cause the one or more processors to:
receive a call to perform a kernel-level operation and
adjust settings of system resources during performance of kernel-level operation.

2. The computer-readable medium of claim 1, wherein the adjust settings of system resources during performance of kernel-level operation is based on a class of service associated with the call and the class of service is based on a source of the call.

3. The computer-readable medium of claim 2, wherein the class of service is based on a system call identifier of kernel code to be executed.

4. The computer-readable medium of claim 1, wherein the settings of the system resources comprise one or more of: power supplied to a core that executes a user-space application that provided the call, frequency supplied to the core that executes a user-space application that provided the call, power supplied to an uncore associated with the core, frequency supplied to the uncore associated with the core, allocated memory bandwidth, power or frequency of an accelerator device, cache prefetcher policy, out of order execution policy, branch prediction policy, and/or device interface specific setting.

5. The computer-readable medium of claim 1, comprising instructions stored thereon, that if executed by one or more processors, cause the one or more processors to:
adjust settings of the system resources to a second level after performance of the called kernel-level operation.

6. The computer-readable medium of claim 5, wherein the second level comprises power and/or frequency settings to core or uncore prior to receipt of the called kernel-level operation.

7. The computer-readable medium of claim 1, comprising instructions stored thereon, that if executed by one or more processors, cause the one or more processors to:
selectively adjust settings of the system resources assigned to perform the kernel-level operation based on telemetry associated with prior executions of the kernel-level operation.

8. An apparatus comprising:
at least one processor and
a system agent communicatively coupled to the at least one processor, wherein:
at least one of the at least one processor, when operational, is configured to:
execute an operating system (OS) to:
receive a call to perform a kernel-level operation and
adjust settings of system resources assigned to perform the kernel-level operation based on a class of service associated with the call.

9. The apparatus of claim 8, wherein the class of service is based on a source of the call.

10. The apparatus of claim 8, wherein the class of service is based on a system call identifier of kernel code to be executed.

11. The apparatus of claim 8, wherein the settings of the system resources comprise one or more of: power supplied to a core that executes a user-space application that provided the call, frequency supplied to the core that executes a user-space application that provided the call, power supplied to an uncore associated with the core, frequency supplied to the uncore associated with the core, allocated memory bandwidth, power or frequency of an accelerator device, cache prefetcher policy, out of order execution policy, branch prediction policy, and/or device interface specific setting.

12. The apparatus of claim 8, wherein the at least one of the at least one processor, when operational, is configured to:
adjust settings of the system resources to a second level after performance of the call to perform the kernel-level operation.

13. The apparatus of claim 12, wherein the second level comprises power and/or frequency settings to core or uncore prior to receipt of the call to perform the kernel-level operation.

14. The apparatus of claim 8, wherein the at least one of the at least one processor, when operational, is configured to:
selectively adjust settings of the system resources assigned to perform the kernel-level operation based on telemetry associated with prior executions of the kernel-level operation.

15. The apparatus of claim 8, comprising a server that comprises the at least one of the at least one processor and the system resources subject to adjusted settings.

16. The apparatus of claim 15, comprising a datacenter that comprises the server, wherein the datacenter comprises a second server that executes an orchestrator and wherein the orchestrator is to configure settings of system resources assigned to perform the kernel-level operation based on a class of service.

17. A method comprising:
adjusting settings of system resources based on class of service associated with a kernel-space operation.

18. The method of claim 17, wherein the class of service is based on a source of a call to perform the kernel-space operation and/or a system call identifier of the kernel-space operation.

19. The method of claim 17, wherein the settings of the system resources comprise one or more of: power supplied to a core that executes a user-space application that provided a call for the kernel-space operation, frequency supplied to the core that executes a user-space application that provided the call, power supplied to an uncore associated with the core, frequency supplied to the uncore associated with the core, allocated memory bandwidth, power or frequency of an accelerator device, cache prefetcher policy, out of order execution policy, branch prediction policy, and/or device interface specific setting.

20. The method of claim 17, comprising:
selectively adjusting settings of the system resources assigned to perform the kernel-space operation based on telemetry associated with prior executions of the kernel-space operation.
